(19) United States
(12) Patent Application Publication
(10) Pub. No.: US 2026/0126334 A1
(43) Pub. Date: May 7, 2026

(54) METHOD AND PORTABLE DEVICE FOR DETECTING LEAKS IN A PIPE

(71) Applicant: ALCOM TECHNOLOGIES, VILLECHETIF (FR)

(72) Inventor: FABRICE GAUTIER, BORDEAUX (FR)

(21) Appl. No.: 18/939,950

(22) Filed: Nov. 7, 2024

(51) Int. Cl. G01M 3/24

(52) U.S. Cl. CPC G01M 3/243

(57) ABSTRACT

A method for electro-acoustic detection of a leak in a pipe conveying a fluid, implemented by a portable device and includes: a step of acquiring a sound signal emitted by the pipe by means of a microphone; a step of processing the signal in real-time with a frequency analysis of the signal by means of a periodogram and extracting features of the signal, including the entropy, a damage-sensitive feature referred to as DSF and a centered frequency corresponding to the barycenter of the periodogram; a step of applying a Kalman filter to estimate residuals; a step of principal component analysis allowing modeling a normal signal of the pipe and of detecting any leak by comparing the signal observed in the normal signal; and an alert and/or notification step in case of detection of a leak.

### BACKGROUND

### Field

The present disclosure relates to the field of devices for processing signals, in particular acoustic signals emitted upon a fluid-structure interaction, and relates, more particularly, to a method for detecting a leak in a pipe conveying any fluid and to a portable device for implementing such a method.

The present disclosure finds a direct, yet non-exclusive, application in the detection of leaks in a drinking water network.

### Brief Description of Related Developments

Pipes, especially those intended for supplying under pressure such as water pipes in a drinking water network or industrial fluid pipes in factories, are subject to various defects that might lead to the apparition of leaks.

These leaks compromise the normal operation of the pipes and may have serious consequences both in technical terms and in economic and environmental terms.

The detection of these leaks often proves to be an arduous task, in particular because of the difficulty of access to the pipes, sometimes buried, and of the size of these.

Some “artisanal” solutions are based on the human analysis of the sound emitted by a pipe and recorded with a microphone or probed with a stethoscope.

These solutions are tedious, barely accurate and require the intervention of technicians having a great expertise.

Document U.S. Pat. No. 4,309,576 describes a listening device for locating water leaks, comprising a manually-actuated rod having a grip at one end for manually positioning the listening device. An acoustic sensing apparatus is mounted at the other end of the rod, and it comprises an audio tone transducer made of ceramic which is operatively connected to an amplifier-receiver which has a level indicator on which visual leak signals could be seen. The acoustic sensing apparatus is also connected to a headset to allow hearing the leaks. The transducer comprises a diaphragm made of brass directly fastened to a threaded pin for mounting in the rod.

There are solutions so-called invasive because they require the introduction of an object into the pipe to carry out the leak detection.

For example, methods are known using a photonic detection technology which transforms an optical fiber cable running along a network of water pipes into thousands of vibration sensors, capable of detecting a disturbance over the entire length of the pipe.

Document FR2935800 describes a method for detecting leaks in an underground liquid pipe, in particular a water pipe, according to which: a gas is injected through a diffuser into the liquid of the pipe, the content of which gas in the atmosphere is low, and the pathway of the pipe is covered at the surface with a detection system to measure, at successive points, the injected gas content in the air, an abnormally high content being a leak indication.

This solution is obviously extremely expensive and very impractical.

Document EP2710291 describes a system for identifying leaks in the construction of hoses for liquids, composed of at least one detection unit positioned proximate to at least one outlet point of said hose construction and comprising an acoustic sensor and a wireless communication unit, of an electronically-controlled closure unit installed on an inlet point of the hose construction, the unit comprising a valve, an acoustic sensor and a wireless communication unit arranged so as to transmit water flow rate data and to receive control signals, and of a controller network device for receiving the measurement data from all sensors. The controller is programmed to detect leaks when it identifies differences between the liquid flow rate measured at the inlet point and the flow rate measured at the outlet points.

Document WO2004/063623 describes a method and a device allowing detecting possible leaks in a pipeline. The pipeline is continuously monitored by acoustic monitoring means, and the acoustic events indicating a possible leak are recorded. The pipeline is also equipped with means for continuous monitoring of the temperature, periodically or on demand. According to this solution, it is estimated that a leak is likely when an acoustic event indicates a possible leak at one location and if, approximately at the same time, a temperature difference higher than a predetermined value is detected between this location and the adjacent locations. In this solution, the temperature may be monitored by a satellite, an aircraft or a drone.

Document EP2028471 describes a leak detector enabling an accurate and stable detection of the presence and of the position of a leak in an underground water pipe. The leak detector includes a vibration detector having a sensor incorporating a piezoelectric element, a main body of the detector incorporating voltage amplifiers for amplifying the voltage of an output signal and several types of noise suppression units for suppressing noises from the output signal and an earphone. The main body of the detector has a display unit for displaying detected sound data on a predefined screen.

These solutions of the prior art are complex to implement and do not allow detecting leaks in short time with high accuracy. In addition, none of these solutions is implemented as a portable device that is simple to use and very compact to facilitate the intervention of leak detection technicians. Document AU2020262969A1 describes a signal detection system for identifying structural anomalies in a pipeline network, but does not disclose the extraction of the DSF (damage-sensitive feature) as well as the extraction of the barycenter of the periodogram, nor the principal component analysis step allowing modeling a normal signal of the pipe and detecting a possible leak by comparing the observed signal with the normal signal.

The document “CLARK CASEY ET A: ”Wireless leak detection using airborne ultrasonics and a fast-Bayesian tree search algorithm with technology demonstration on the ISS“2015 IEEE International Conference on Wireless for Space and Extreme Environments (WiSEE), IEEE, Dec. 14, 2015” relates to a method for detecting leaks in a pipe which uses the periodogram and which is implemented by a portable device comprising a microphone. This document does not disclose at least the extraction of the DSF and the PCA analysis.

The document “ Toshitaka Sato, Akira Mita: ”Leak detection using the pattern of sound signals in water supply systems“, Proceedings volume 6529, sensors and smart structures technologies for Civil, Mechanical, and Aerospace systems 2007, Vol. 6529, Apr. 6, 2007” relates to a method for detecting leaks in a pipe which relates to the PCA model and DSF methods, but does not disclose the extraction of the features (barycenter and entropy) and the combination of the results of the extracted features (entropy, DSF and barycenter) and the PCA analysis.

### SUMMARY

The present disclosure aims to overcome the drawbacks of the prior art set out hereinbefore and proposes a solution that is simple to use enabling an automatic detection of leaks in a pipe in a very short time (less than one minute).

A main objective of the disclosure is to provide a portable device allowing instantaneously identifying the existence or absence of leaks in a pipe with a very high acuity, which could reach 100% in most cases.

Another objective of the disclosure is to use a set of artificial intelligences to optimize the leak detection and make it discreet and fast, and therefore adapted to be implemented in a laptop or in a smartphone-type mobile phone.

To this end, an object of the present disclosure is a method for electro-acoustic detection of a leak in a pipe conveying a fluid, comprising:
a step of acquiring a sound signal emitted by the pipe by means of a microphone; and
a step of processing the signal in real-time.

This method is remarkable in that the signal processing step comprises:
a step of frequency analysis of the signal by means of a periodogram; and
a step of extracting features of the signal, including the entropy, a damage-sensitive feature referred to as DSF (Damage-Sensitive Feature) and a centered frequency corresponding to the weighted barycenter of the periodogram.

It should be noted that the weights and the coefficients used in the previous computations are optimized by a genetic algorithm for each application after a learning period.

This method is also remarkable in that it comprises, after the steps hereinabove:
a step of applying a Kalman filter to estimate residuals corresponding to leak-revealing signals;
a principal component analysis (PCA) step allowing modeling a normal signal of the pipe and detecting any leak by comparing the observed signal with the normal signal; and
a step of presenting the results and alerting and/or notifying in case of detection of a leak. Finally, this method is remarkable in that it is entirely implemented by a portable device comprising the microphone.

For a better result, the entropy of the signal is computed with an approximate entropy ApEn (Approximate Entropy) model.

Advantageously, the feature DSF is computed from an AR (autoregressive) model of the signal. More particularly, the AR model of the signal is an integrated moving-average model ARIMA (Auto-Regressive Integrated Moving Average) having ARIMA coefficients, and the feature DSF is equal to the ratio between the first ARIMA coefficient and the square root of the sum of the squares of the first three ARIMA coefficients.

According to an advantageous aspect, the step of PCA analysis of the signal implements neural network type artificial intelligence algorithms to improve leak detection by assigning a weight to each feature computed in the feature extraction step. It should be noted that the weights and the coefficients used in the previous computations are optimized by a genetic algorithm for each application after a learning period.

Another object of the present disclosure is a portable device comprising a microphone and computing means in the form of a microprocessor, for implementing a method for detecting leaks in a pipe as disclosed.

Advantageously, the portable device comprises a smartphone-type mobile terminal connected to the microphone, the method then being executed in a dedicated mobile application.

The fundamental concepts of the disclosure having just been described hereinabove in their most elementary form, other details and features will appear more clearly upon reading the following description and with reference to the appended drawings, giving as a non-limiting example, an aspect of a method and of a device for detecting leaks in a pipe, in accordance with the principles of thedisclosure.

### BRIEF DESCRIPTION OF THE FIGURES

The figures are given for merely illustrative purposes for understanding of the disclosure and do not limit the scope of the latter. The different elements are shown schematically and not necessarily to the same scale. In all figures, identical or equivalent elements bear the same reference numeral.

Thus, it is illustrated in:

FIG. 1: a portable leak detection device placed proximate to a pipe, according to a first aspect of the disclosure;

FIG. 2: a flowchart of the main steps of a method for detecting a leak in a pipe according to the disclosure;

FIG. 3: a portable leak detection device, according to a second aspect of the disclosure.

### DETAILED DESCRIPTION

In the aspect described hereinafter, reference is made to a portable device for detecting leaks in a pipe, intended primarily for searching for leaks in water pipes. This non-limiting example is given for a better understanding of the disclosure and does not exclude the use of the device to search for leaks in other pipes such as pipelines, gas pipelines, oil pipelines and more generally all circulations of industrial fluids in factories or plants.

In the present description, the term “portable device” refers to a small-size device that a user can carry with his/her hands for use thereof, like a mobile phone.

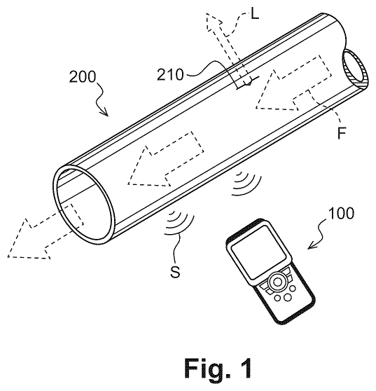

FIG. 1 shows a portable leak detection device 100 placed proximate to a pipe 200 in which a fluid F flows according to a normal flow direction (in thick arrows).

The pipe 200 is subject to a leak L (in thin arrow) caused in particular by a damage such as a crack 210.

Of course, the leak L induces a particular acoustic signature in the sound signal S produced by the fluid that flows in the pipe 200.

Thus, the portable device 100 allows probing the sound signal S emitted by the pipe 200 and detecting the presence of the leak L by recognizing the acoustic signature of the latter.

Prior to this recognition, a microphone integrated or connected to the portable device 100 enables an acquisition of the sound signal S when it is placed proximate to the pipe 200.

Of course, the recognition of the acoustic signature is the result of a processing of the specific signal performed by computing means of the portable device 100.

Thus, thanks to its microphone and its on-board computing means, the portable device 100 implements a leak detection method according to the present disclosure.

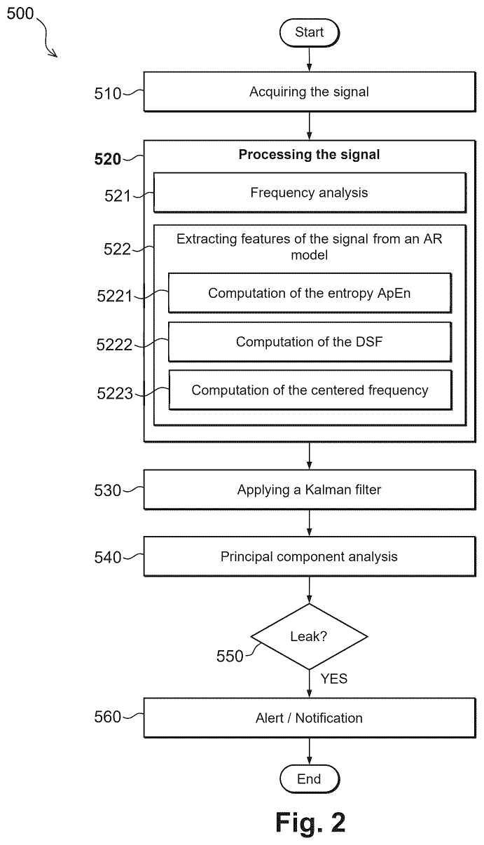

FIG. 2 shows the main steps of a method 500 for detecting a leak in a pipe, said method comprising:
a step 510 of acquiring the sound signal emitted by the pipe;
a step 520 of processing this signal according to a sequence of well-defined operations;
a step 530 of applying a Kalman filter;
a step 540 of principal component analysis;
a step 550 of verifying the presence of a leak; and
an alert and/or notification conditional step 560 in case of leak detection.

Step 510 of acquiring the sound signal consists in recording this signal with the microphone of the portable device 100, at different accessible points of the pipe.

Afterwards, the signal is analyzed in a processing and computing unit of the portable device 100. Step 520 of processing the signal is carried out according to a frequency approach on the continuous signal which is the sound signal of the pipe. This consists of a digital processing of the signal carried out in real-time in an on-board microprocessor, preferably one specialized in digital signal processing.

The processing of the signal performed during step 520 comprises:
a step 521 of frequency analysis of the signal; and
a step 522 of extracting features of the signal;

The frequency analysis step 521 consists in obtaining a frequency representation of the recorded signal using a periodogram (periodogram) in order to estimate the power spectral density (PSD).

Indeed, in the context of harmonic analysis, the DSP allows characterizing the random and stationary signal which is the sound signal of the pipe.

This allows identifying the harmonics (or fundamental frequencies) of the sound signal, which therefore correspond to a normal operation of the pipe, and removing the external sounds of the environment which are sounds that are parasitic to the sought leak.

Step 522 of extracting features of the signal consists in computing features from an AR model (autoregressive) of the previously established signal.

In particular, this feature extraction comprises a computation 5221 of the entropy, a computation 5222 of a damage-sensitive feature referred to as DSF (Damage-Sensitive Feature) and a computation 5223 of the centered frequency (centered frequency) which is the barycenter of the periodogram.

Indeed, as soon as there is an anomaly in the operation of the pipe and that this anomaly modifies the resulting sound signal, there is necessarily more complexity in said signal and therefore more entropy. Thus, the entropy of the sound signal of a pipe with leaks is necessarily higher than that of the signal of the same pipe without leaks.

Preferably, the entropy of the recorded signal is computed with the approximate entropy ApEn (Approximate Entropy) statistical model. The ApEn model has allowed obtaining better results, compared to other models for computing the entropy such as the sample entropy SampEn (Sample Entropy), which is a ApEn derived model, or the Kolmogorov-Sinai entropy.

In addition, the model ApEn has many advantages, in particular a low computing consumption, an operation for small data samples, a real-time operation and a limited effect of the noise on the measurements.

Preferably, the AR model of the signal is an autoregressive integrated moving-average model ARIMA (Auto-Regressive Integrated Moving Average) whose ARIMA coefficients allow computing the DSF which is equal to the ratio of the first coefficient and of the square root of the sum of the squares of the first three coefficients.

Thus, the normal signals have frequencies concentrated in the same region, whereas the abnormal signals (with leaks) do not have such a frequency concentration.

Afterwards, based on all these features, a principal component analysis PCA and a Kalman filter are applied, to detect and locate a possible leak in the pipe.

Indeed, step 530 of applying a Kalman filter allows estimating the state of the system representing the flow in the pipe, in order to generate the residuals of the system, based on a proper operation model of the system (without leaks) and the available measurements, these residuals being the acoustic signatures revealing the presence of leaks in the pipe.

The PCA analysis step 540 allows generating a PCA model in which all of the correlations between the different features are taken into account.

Thus, the PCA analysis allows modeling the behavior of the pipe (system) in normal operation, and the leaks (damages) are then detected by comparing the behavior observed in the recorded sound signal and that one given by the PCA model.

The combination of the results of the features extracted in step 520 and the PCA analysis allows obtaining a segmentation of a two-dimensional space in which are projected the vectors of a space of greater dimension (5 for example) based on the extracted features. This segmentation separates the signals without leaks from the signals with leaks and therefore allows detecting the leaks.

Preferably, the method 500 implements artificial intelligence algorithms of the neural network type to improve the PCA analysis by assigning a weight to each of the features computed in step 520. It should be noted that the weights and the coefficients used in the previous computations are optimized by a genetic algorithm for each application after a learning period.

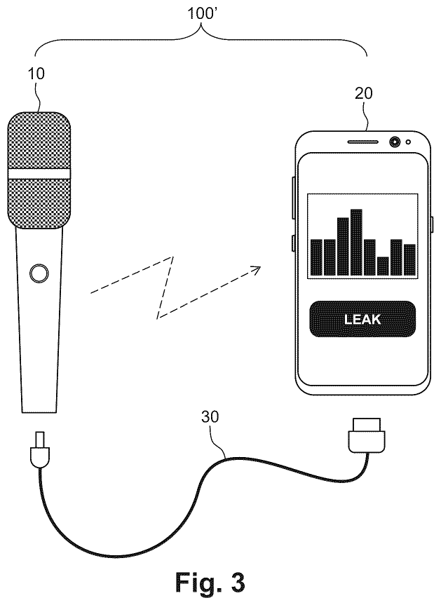

FIG. 3 shows a portable device 100′, according to another aspect, for the implementation of the leak detection method, said device comprising a detached microphone 10 and a mobile terminal such as a smartphone 20.

The microphone 10 and the smartphone 20 may be connected with a cable 30 or through a wireless link.

Thus, the portable leak detection device can be transported and used simply by a technician wishing to verify the condition of a pipe.

It clearly arises from the present description that some steps of the method could be modified, replaced or suppressed and that some adjustments could be made to the implementation of this method according to the targeted objectives, yet without departing from the scope of the disclosure.

What is claimed is:

1. A method for electro-acoustic detection of a leak in a pipe conveying a fluid, comprising:
a step of acquiring a sound signal emitted by the pipe by means of a microphone; and
a step of processing the signal in real-time;
characterized in that the signal processing step comprises:
a step of frequency analysis of the signal by means of a periodogram allowing estimating the power spectral density of said signal; and
a step of extracting features of the signal, including the entropy, a damage-sensitive feature referred to as DSF and a centered frequency corresponding to the barycenter of the periodogram;
and in that it comprises, after the steps hereinabove:
a step of applying a Kalman filter to estimate residuals corresponding to leak-revealing signals, these residuals being acoustic signatures revealing the presence of a leak in the pipe;
a principal component analysis step allowing modeling a normal signal of the pipe and detecting any leak by comparing the observed signal with the normal signal; and
a step of presenting the results and alerting and/or notifying in case of detection of a leak;
and in that it is entirely implemented by a portable device comprising the microphone

2. The method according to claim 1, wherein the entropy of the signal is computed with an approximate entropy model.

3. The method according to claim 1, wherein the feature DSF is computed from an autoregressive model of the signal.

4. The method according to claim 3, wherein the autoregressive model of the signal is an integrated moving-average model having so-called ARIMA coefficients, and the feature DSF is equal to the ratio between the first ARIMA coefficient and the square root of the sum of the squares of the first three ARIMA coefficients.

5. The method according to claim 1, wherein the step of principal component analysis of the signal implements artificial intelligence algorithms to improve leak detection by assigning a weight to each feature computed in the feature extraction step.

6. The method according to claim 4, wherein:
the step of principal component analysis of the signal implements artificial intelligence algorithms to improve leak detection by assigning a weight to each feature computed in the feature extraction step; and
the weights and the coefficients used in the computations are optimized by a genetic algorithm for each implementation after a training period.

7. A portable device comprising a microphone and computing means in the form of a microprocessor, for implementing a method for detecting leaks in a pipe according to claim 1.

8. The portable device according to claim 7, comprising a smartphone-type mobile terminal connected to the microphone the method being executed in a dedicated mobile application.
